(19) United States
(12) Patent Application Publication
(10) Pub. No.: US 2007/0294509 A1
(43) Pub. Date: Dec. 20, 2007

(54) Network Processor

(75) Inventor: Christian Sauer, Ottobrunn (DE)

Correspondence Address: DICKSTEIN SHAPIRO LLP, 1177 AVENUE OF THE AMERICAS 6TH AVENUE, NEW YORK, NY, 10036-2714, US

(73) Assignee: INFINEON TECHNOLOGIES AG, Munich (DE)

(21) Appl. No.: 11/572,288

(22) PCT Filed: Jul. 7, 2005
(86) PCT No.: PCT/DE05/01203

§ 371 Date: Aug. 6, 2007

(30) Foreign Application Priority Data
Jul. 23, 2004 (DE) 10 2004 035 843.5

(51) Int. Cl. G06F 15/00

(52) U.S. Cl. 712/14

(57) ABSTRACT

The invention relates to a network processor provided with a plurality of programmable processor elements. One part of the plurality of processor elements is embodied as interface processor elements which are used to provide an output communication interface and/or an input communication interface according to a communication processor for the network processor.

The invention relates to a network processor.

With the growth of the Internet and the associated growth of the volume of data to be transmitted, it is becoming increasingly important to develop and manufacture hardware which can be used to perform the tasks arising on the Internet in the course of data transmission efficiently.

In particular, a large number of network processors have recently been developed which are also called communication processors or NPUs. Network processors are programmable and have specific system-on-chip (SoC) architectures suitable for processing data packets.

Network processors typically have processor elements, memory hierarchies, connecting networks, that is to say internal communication networks, and communication interfaces.

When developing an architecture for a network processor, the focal point is typically the optimization of the interaction between the processor elements, the memory hierarchies and the connecting networks.

However, communication interfaces are frequently underestimated in terms of their complexity, are given little consideration during system development and are provided relatively late in the development process separately as standard IP (Intellectual Property) blocks.

To be able to meet the demands of networked high-end computer systems on communication interfaces in terms of efficiency and performance, that is to say bandwidth per pin on a network processor, there is an increasing requirement for communication interfaces which allow the transmission of data using newly developed communication protocols at chip level and at board level, such as Hypertransport, RapidIO and PCI Express, however.

The development of these communication protocols is not complete, however, and changes to the communication protocol standards are frequently made.

Designing network processors, which have complex communication interfaces allowing the transmission of data on the basis of such communication protocols as those mentioned above, requires a complex design process because the network processors designed are otherwise inflexible and below optimum in respect of their communication interfaces.

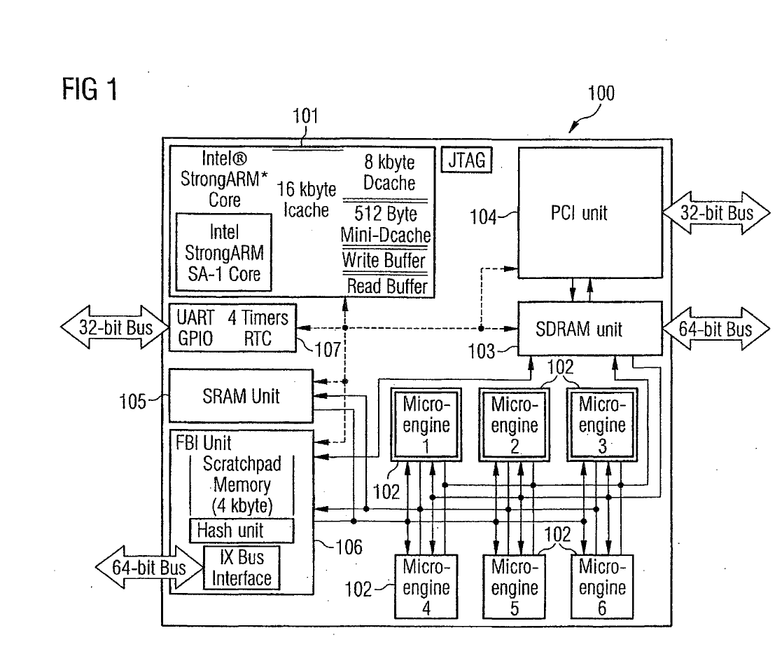

FIG. 1 shows a conventional network processor 100, the 1XP1200 from Intel, which is described in [1].

The network processor 100 has a microprocessor of the StrongARM type 101 and also a plurality of RISC microprocessors 102. In addition, the network processor has an SDRAM unit 103, which allows access to external SDRAM (Synchronous Dynamic Random Access Memory), a PCI unit 104, which provides a communication interface based on PCI (Peripheral Component Interconnect), an SRAM unit 105, which allows access to external SRAM (Static Random Access Memory), an FBI (First-in First-out Bus Interface) unit 106, which provides a proprietary communication interface, the IX (Internet exchange) bus interface, in particular, and also other functional units 107.

The area proportion of the functional elements which provide communication interfaces, that is to say the SDRAM unit 103, the PCI unit 104, the SPAM unit 105 and the FBI unit 106, forms approximately 30% of the total area of that of the network processor 100 and thus clarifies the significance of the communication interfaces.

In addition, the SoC architecture of the network processor 100 shows that a large number of communication interfaces are implemented heterogeneously and individually, that is to say using different functional units, in the network processor 100.

The network processor 100 has functional units providing communication interfaces, which functional units are more complex than the RISC microprocessors 102. By way of example, the PCI unit 104, if suitable for providing a communication interface based on PCI (Version 2.2), is about as large as four of the microprocessors 102 in terms of the area it takes up.

The area of a functional unit is typically an indication of the complexity of the functional unit.

On the basis of the prior art, communication interfaces are implemented in network processors in the various ways explained below.

As in the case of the network processor 100 shown in FIG. 1, which, as mentioned, is explained in [1], each communication interface required is implemented separately, that is to say using a separate functional unit, and is coupled to dedicated pins.

As explained above, this results in a large area requirement for the functional elements providing the communication interfaces and also results in the network processor having a large number of heterogeneous blocks, that is to say a large number of functional elements, whose structure bears little resemblance to one another.

The high level of specialization of the functional elements for specific communication interfaces also means that the flexibility of the network processor 100 is low.

In another class of network processors, for example in the case of the network processor NP4GS3 (Rainier) from IBM described in [2], the same pins are used for a plurality of different communication interfaces, to be explicit a plurality of inflexible communication interface macros share pins.

On the pins which are used for a plurality of communication interfaces, network processors of this kind appear flexible in respect of the communication interfaces, but likewise have a relatively heterogeneous structure, and the functional elements which provide the communication interfaces have a relatively large area requirement, as in the case described above.

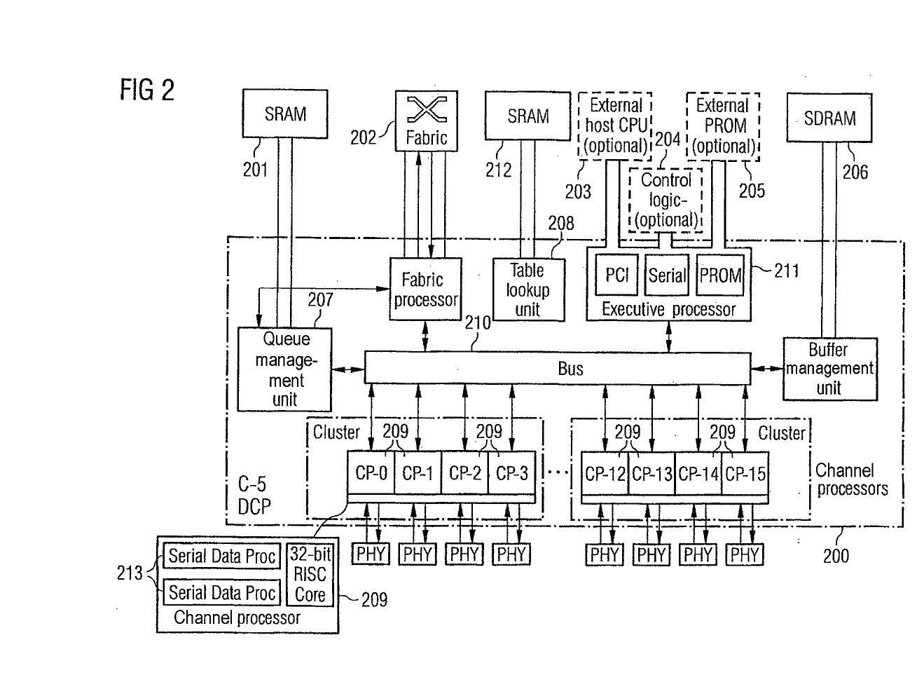

An example of a network processor from another class of network processors is shown in FIG. 2.

The network processor 200 shown in FIG. 2 is the C-5DCP (Digital Communications Processor) from Motorola, which is described in [3].

In the illustration in FIG. 2, the network processor 200 is coupled to a plurality of external functional elements, a first SRAM 201, a second SRAM 212, a fabric 202, for example a switch fabric, an external microprocessor 203, a control unit 204, an external PROM (Programmable Read Only Memory) 205 and an SDRAM 206.

In addition to a plurality of functional elements, for example a queue management unit 207 and a table lookup unit 208, the network processor 200 has a plurality of processor elements (channel processors) 209.

The processor elements 209 are coupled to one another by means of a computer bus 210.

The processor elements 209 have coprocessors 213. The coprocessors 213 are (micro)programmable to a relatively small extent and, with suitable programming, provide communication interfaces, for example on the basis of ATM (Asynchronous Transfer Mode) or Ethernet.

On account of the programmability of the coprocessors 213, the network processor 200 has relatively average flexibility, a lower level of heterogeneity in comparison with the network processor described above, and a relatively average area requirement for the functional elements which provide communication interfaces.

In another class of network processors, for example in the case of the network processor IP3023 from Ubicom, which is described in [4], communication interfaces are provided by programming a central general purpose processor, to be explicit the communication interfaces are thus implemented entirely in software. Central means that the general purpose processor may also perform other tasks at the same time.

This achieves a relatively very high level of flexibility in respect of the provision of communication interfaces and, if a general purpose processor is available on the network processor, no additional area requirement is needed for providing communication interfaces.

So that such a network processor can be used to meet the demands which arise for real-time applications, there are typically substantial demands on the operating system used for the network processor, however, which can be met only with considerable involvement.

Since, in addition, programming a general purpose processor allows only communication interfaces with relatively low power to be provided, that is to say which can be used only for data transmission at a relatively low data rate, the provision of communication interfaces by programming a general purpose processor can be used only for communication interfaces with a low power requirement.

[5] describes an earlier version of the network processor shown in FIG. 2.

[6] describes an architecture for a data processing system in which an input device is set up to receive a stream of data packets, and a plurality of processing elements are set up to process the data received from the input device.

Document [7] describes an array of parallel, programmable processing elements which are coupled to one another by means of a switching network.

[8] describes a System-on-Chip architecture which provides scaleable, distributed processing options and storage options using a plurality of processing layers.

The invention is based on the problem of providing high-power communication interfaces for a network processor, where the functional elements which are used to provide the communication interfaces have a low area requirement and the network processor has a relatively low level of heterogeneity and also is flexible in respect of the communication interfaces.

The problem is solved by a network processor having the features based on the independent patent claims.

A network processor having a plurality of programmable processor elements is provided in which each processor element from the plurality of processor elements is set up to provide communication network protocol basic functions; a first portion of the plurality of processor elements are set up as communication network processor elements; and a second portion of the plurality of processor elements are set up as interface processor elements which are set up to provide an output communication interface and/or an input communication interface on the basis of a communication protocol for the network processor.

One idea on which the invention is based can clearly be seen as being that complete processor elements, which differ from the processor elements which perform the “actual” packet processing tasks and communication network tasks only in terms of their programming, are used to provide communication interfaces.

Another idea on which the invention is based can be seen as being that use is made of the functional similarity between units which provide communication interfaces and a network processor's processor elements designed for specific problems.

This achieves a high level of homogeneity for the system architecture of the network processor, and in particular a rapid system design is made possible, which requires little implementation involvement.

In addition, the interface processor elements can be programmed using the same development tools as for programming the communication network processor elements. This clearly achieves a homogeneous development environment.

In addition, the network processor provided is very flexible in respect of its communication interfaces on account of the programmability of the interface processor elements. Therefore, the network processor can be used within the context of a broad spectrum of communication protocols, for example within the context of an arbitrary combination of communication protocols which has come about through a market alliance, for example.

It is also possible for the network processor to be matched to developing communication interface standards. This is of considerable importance, since the field of communication networks has a large number of communication interface standards which are still being developed.

In comparison with a network processor whose communication interfaces have a particular power, the area requirement of the functional units in the network processor provided, which provide the same communication interfaces at the same power, is very low.

Preferred developments of the invention can be found in the dependent claims.

It is preferred that each processor element from the plurality of processor elements has a bit operation unit for executing operations at bit level, a timer for providing a clocked counter, and a checksum processing unit for processing checksums.

In particular, communication network protocol basic functions are understood to mean operations at bit level and checksum processing, for example.

Another preference is that each processor element from the plurality of processor elements has a memory for storing data, program instructions and state information and/or a program instruction decoding unit for decoding program instructions.

Preferably, the output communication interface and/or the input communication interface is a switch fabric interface for a switch fabric.

Another preference is that the output communication interface and/or the input communication interface is/are set up on the basis of RapidIO, Hypertransport, PCI Express (Peripheral Component Interconnect Express), CSIX (Common Switch Interface), Ethernet, IEEE 802.3, Token-Ring or ATM (Asynchronous Transfer Mode).

Another preference is that the network processor also has at least one hard macro, and a process which needs to be implemented in order to provide the output communication interface and/or the input communication interface is implemented using program instructions executed on at least one of the interface processor elements or using the at least one hard macro.

Exemplary embodiments of the invention are illustrated in the figures and are explained in more detail below.

FIG. 1 shows a conventional network processor.

FIG. 2 shows a conventional network processor.

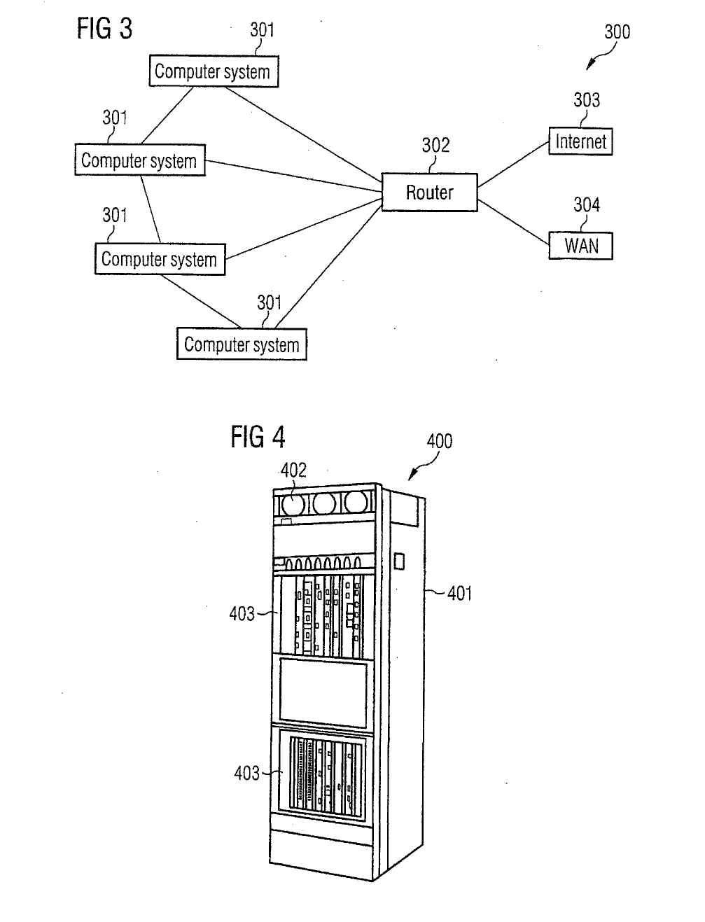

FIG. 3 shows a computer network based on an exemplary embodiment of the invention.

FIG. 4 shows a router based on an exemplary embodiment of the invention.

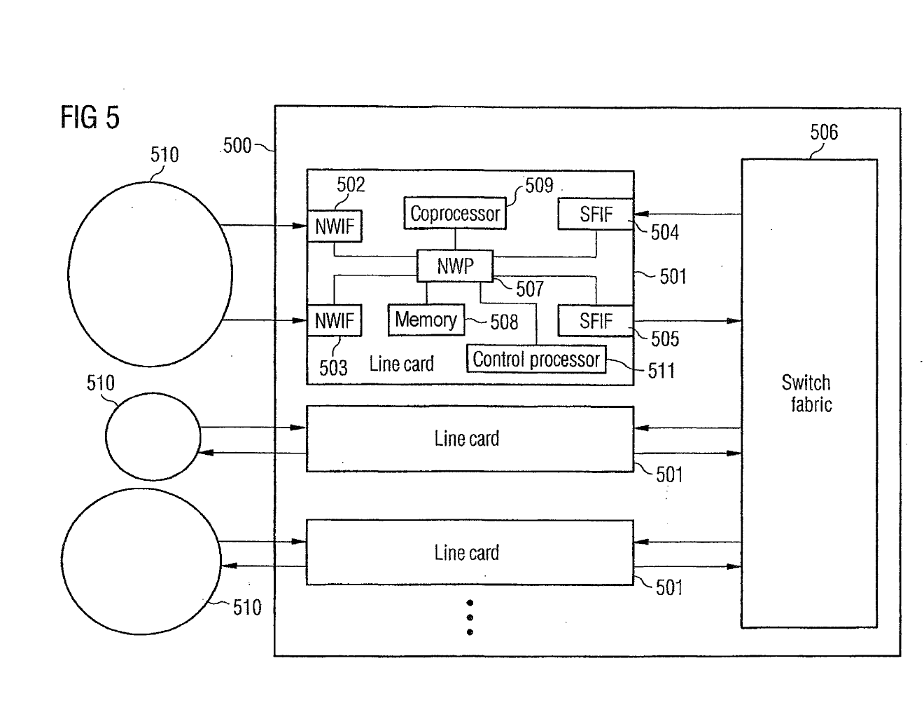

FIG. 5 shows a router based on an exemplary embodiment of the invention.

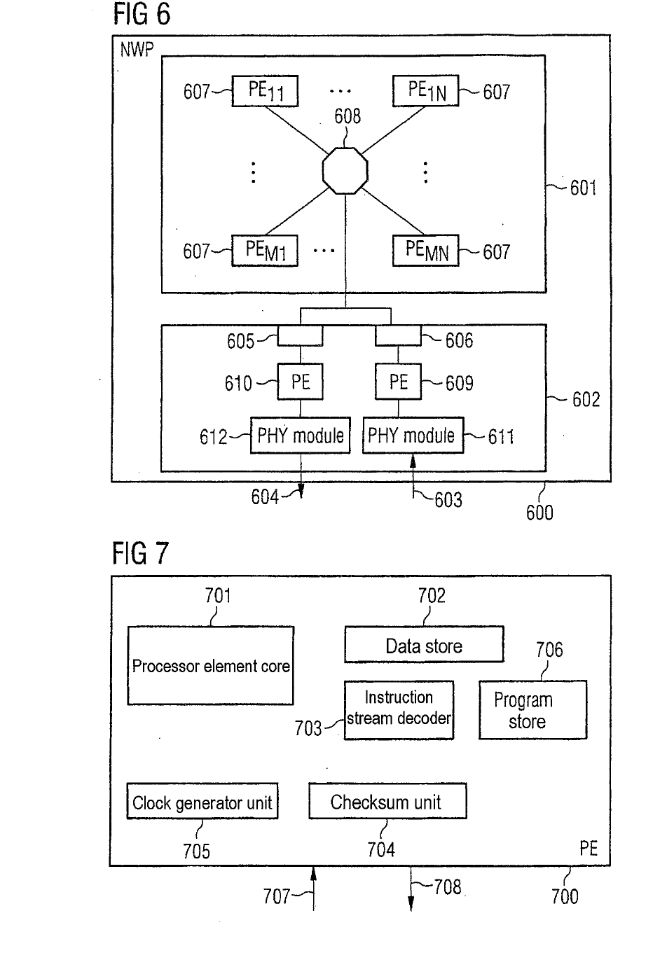

FIG. 6 shows a network processor based on an exemplary embodiment of the invention.

FIG. 7 shows a processor element based on an exemplary embodiment of the invention.

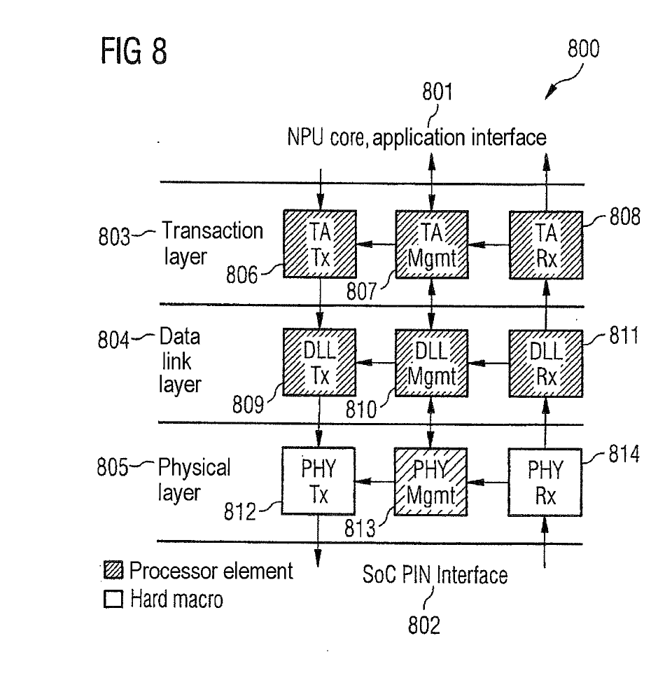

FIG. 8 shows a data flowchart based on an exemplary embodiment of the invention.

FIG. 3 shows a computer network 300 based on an exemplary embodiment of the invention.

A plurality of computer systems 301, for example personal computers or workstations, are coupled to one another and to a router 302.

The computer systems 301 communicate with one another and with the router 302 on the basis of a communication protocol based on layer 2 of the OSI/ISO reference model, for example Ethernet, IEEE 802.3 (Institute of Electrical and Electronics Engineers), Token-Ring or ATM (Asynchronous Transfer Mode).

The router 302 couples the computer systems 301 to the Internet 303, to a WAN (Wide Area Network) 304 and possibly to other computer networks.

Among other things, the router 302 ensures that data which are sent by one of the computer systems 301 to the Internet 303 or to the WAN 304 reach their intended destination and that data which are sent by a computer, for example a server computer, from the Internet 303 or from the WAN 304 to one of the computer systems 301 reach this computer system.

Within the context of this task, the router 302 performs tasks such as address lookups.

The router 302 may have other tasks relating to the classification, prioritization or routing of data packets, or it may have a firewall, for example, which ensures the safety of the computer systems 301 against hacker attacks from the Internet 303 or from the WAN 304.

By way of example, the router 302 may be designed as explained below with reference to FIG. 4.

FIG. 4 shows a router 400 based on an exemplary embodiment of the invention.

In addition to a housing 401 and a plurality of fans 402, the router 400 has a multiplicity of line cards 403 which are distributed over two line card blocks and are fitted in slots in the router 400 which are intended for this purpose.

In addition, FIG. 4 reveals that the line cards 403 have sockets allowing the connection of cable connections which can be used to supply the respective line card with data and which the respective line card 403 can use to send data.

The architecture of the router 400 is explained below with reference to FIG. 5.

FIG. 5 shows a router 500 based on an exemplary embodiment of the invention.

The router 500 has a plurality of line cards 501 which couple the router 500 to a respective computer network 510.

By way of example, a computer network is a LAN (Local Area Network), a WAN, such as the WAN 304, the Internet or the computer network formed by the computer systems 301.

The line cards 501 are coupled to a switch fabric 506 (backplane). The switch fabric 506 allows the transmission of data packets from one of the line cards 501 to other line cards 501, and vice versa.

The design of the line cards 501 is explained below by way of example with reference to a line card 501.

The line card 501 has an input network interface 502 and an output network interface 503.

Using the input network interface 502, the line card 501 receives data which are sent by the computer network 510 to which the line card 501 is coupled. Using the output network interface 503, the line card 501 sends data to the computer network 510.

The data transmission using the input network interface 502 and the output network interface 503 is effected on the basis of the Ethernet protocol, on the basis of IEEE 802.3, on the basis of the Token-Ring protocol or on the basis of ATM, for example.

The line card 501 also has an input switch fabric interface 504 and an output switch fabric interface 505.

Using the input switch fabric interface 504, the line card 501 receives data sent from the switch fabric 506 to the line card 501.

Using the output switch fabric interface 505, the line card 501 sends data to the switch fabric 506.

The data transmission between the line card 501 and the switch fabric 506 using the input switch fabric interface 504 and the output switch fabric interface 505 is effected on the basis of the RapidIO protocol, the Hypertransport protocol, the PCI Express protocol or the CSIX (Common Switch Interface) protocol, for example.

The line card 501 has a network processor 507.

The network processor 507 is coupled to the input network interface 502, to the output network interface 503, to the input switch fabric interface 504 and to the output switch fabric interface 505 and has functional units which allow the transmission of data on the basis of the communication protocols on the basis of which the input network interface 502, the output network interface 503 and the input switch fabric interface 504 and the output switch fabric interface 505 are used to transmit data.

An example of one task of the network processor 507 is to check data which the network processor 507 receives using the input network interface 502 for transmission errors, for example to carry out a CRC error check and to forward the data to the switch fabric 506 using the output switch fabric interface 505.

The switch fabric 506, for its part, forwards the data to one of the line cards 501 using the input switch fabric interface 504, on the basis of the intended recipient of the data, the computer network 510 coupled to the respective line card 501 and the utilization level of the computer network 510 coupled to the line card 501, so that a load distribution (load balancing) is achieved, for example.

Data which the switch fabric 506 sends, using the input switch fabric interface 504, to the network processor 507 for the purpose of forwarding to the computer network 510 coupled to the line card 501 are processed by the network processor 507, which forwards them to the physical network using the output network interface 503.

By way of example, the processing may involve the network processor 507 adding error checksums to the data or encrypting the data.

Another task of the network processor 507 is to send data, which it receives on the basis of a particular communication protocol (see the examples above) using the input network interface 502 or the input switch fabric interface 504, on the basis of a typically different communication protocol (see likewise the examples above) using the output network interface 503 or the output switch fabric interface 505.

Clearly, one task of the network processor 507 is therefore to translate one communication protocol into another.

The network processor 507 is also coupled to a coprocessor 509, which supports the network processor 507 in performing the tasks of the network processor 507, and to a superordinate control processor 511 which coordinates the work of the network processor 507.

In one embodiment, the router 500 may also have a shared control processor 511 for all the line cards 501. Both variants (one control processor 511 for each line card 501 or one control processor 511 for all the line cards 501) are supported by PCI Express.

In addition, the network processor 507 accesses a (or a plurality of) memory (memories) 508 to which the network processor 507 is coupled.

By way of example, the memory 508 contains a lookup table which the network processor 507 can use to determine the next hop for a data packet which the network processor 507 has received.

The memory 508 is an SRAM or an SDRAM, for example.

In addition to the external memory 508, the network processor 507 also has an internal memory (not shown).

The network processor 507 may be set up and designed as explained below with reference to FIG. 6, for example.

FIG. 6 shows a network processor 600 based on an exemplary embodiment of the invention.

The network processor 600 has a network processor core (NPU core) 601 and a communication interface unit 602.

In this example, the communication interface unit 602 allows the transmission of data using the input switch fabric interface 504 shown in FIG. 5 and the output switch fabric interface 505 and therefore allows the transmission of data on the basis of the relevant communication protocols (see the examples cited above).

The transmission of data using the input network interface 502 and/or the output network interface 503 is made possible using a (or a plurality of) further communication interface unit(s) (not shown).

In one embodiment, the further communication interface unit(s) likewise provide(s) the interfaces between the network processor 507 and the coprocessor 509 and/or between the network processor 507 and the control processor 511, with an appropriate communication protocol being used, for example Hypertransport.

An input 603 of the communication interface unit 602 has the input switch fabric interface 504 coupled to it, for example, and an output 604 of the communication interface unit 602 has the output switch fabric interface 505 coupled to it in this example.

The network processor 600 is designed on the basis of a System-on-Chip (SoC) architecture.

From the point of view of the physical layer, the input 603 and the output 604 are in the form of pins of the network processor 600.

The network processor core 601 is coupled to the communication interface unit 602 by means of an output interface 605 and by means of an input interface 606. The input interface 605 and the output interface 606 are in the form of standard SoC connection interfaces, for example based on a conventional microprocessor computer bus.

The network processor core 601 has a plurality of communication network processor elements 607. The communication network processor elements 607 are coupled to one another by means of a connecting network 608.

The connecting network 608 may have any desired topology, for example the communication network processor elements 607 may be coupled to one another completely or may be coupled to one another on the basis of a ring topology.

The connecting network 608 is coupled to the communication interface unit 602 by means of the output interface 605 and the input interface 606.

In this exemplary embodiment, the communication network processor elements 607 are arranged in the form of an M×N matrix. M and N are arbitrary natural numbers, in particular the number of communication network processor elements 607 is arbitrary.

The communication interface unit 602 has an input processor element 609 and an output processor element 610.

The input processor element 609 is coupled to the input 603 by means of a first PHY module 611 and to the input interface 606.

The output processor element 610 is coupled to the output 604 by means of a second PHY module 612 and to the output interface 605.

The first PHY module 611 and the second PHY module 612 implement the physical layer of the communication interface which is provided by means of the communication interface unit 602.

The processor elements 607, 609, 610 of the network processor 600, that is to say the communication network processor elements 607, the output processor element 610 and the input processor element 609, are programmable and each have a separate memory (not shown) for the respective program code, the respective state information and data.

The more precise design of the processor elements 607, 609, 610 is explained further below with reference to FIG. 7.

The memory in the output processor element 610 can be addressed directly by the network processor core 601 using the output interface 605, and the memory in the input processor element 609 can be addressed by the network processor core 601 directly using the input interface 606.

The network processor core 601 and the communication network processor elements 607 therefore have access to the data stored in the memory of the output processor element 610 and in the memory of the input processor element 609 and, in particular, to the data which are to be transmitted and received by means of the communication interface unit 602 and which are stored in the transmission memories (transaction memories), which respectively form part of the memory of the output processor element 610 and of the memory of the input processor element 609.

With suitable programming, the output processor element 610 allows data to be sent using the output 604 on the basis of a desired communication protocol which corresponds to the programming of the output processor element 610.

With suitable programming, the input processor element 609 allows data to be received using the input 603 on the basis of a communication protocol which corresponds to the programming of the input processor element 609.

By way of example, the communication network processor elements 607 use a memory mapping addressing method to access the communication interfaces provided by the communication interface unit 602.

In this exemplary embodiment, the communication interface unit 602 has just two processor elements, namely the input processor element 609 and the output processor element 610.

In particular, just one respective processor element is provided for sending data and for receiving data.

In other embodiments, the communication interface unit 602 may have one or more processor elements, however, depending on the power demands on the communication interfaces provided by means of the communication interface unit 602 and the data throughput rate which needs to be achieved by means of the communication interface unit 602.

FIG. 7 shows a processor element 700 based on an exemplary embodiment of the invention.

The processor element 700 has a processor element core 701, a data store 702, an instruction stream decoder 703, a checksum processing unit 704, a timer unit 705 and a program store 706.

The instruction stream decoder 703 decodes program instructions stored in the program store 706 and routes them to the processor element core 701, which executes the decoded program instructions.

When executing program instructions, the processor element core 701 may access the data store 702. By way of example, the data store 702 stores data packets which the processor element core 701 processes on the basis of the decoded program instructions.

The timer unit 705 provides a clocked counter for the processor element and hence provides a time base for implementing the communication protocol function.

The checksum processing unit 704, for example a CRC unit, is a functional unit which specializes in performing checksum processing operations.

By way of example, the checksum processing unit 704 can be used to calculate the CRC field in the message header of a data packet efficiently.

The instruction set of the processor element 700, on the basis of which the program instructions stored in the program store 706 are formed, contains instructions allowing operations at bit level (bit level operations), in particular. By way of example, the instruction set might have an instruction which allows a data word stored in a register in the processor element core 701 to be altered bit by bit or which allows two data words respectively stored in a register in the processor element core 701 to be linked using a logic AND operation bit by bit and the result to be stored in a third register in the processor element core 701.

The processor element 700 also has an input 707 and an output 708.

FIG. 8 shows a data flowchart 800 based on an exemplary embodiment of the invention.

The data flowchart 800 illustrates the operation of the communication interface unit 602 which is shown in FIG. 6 and is explained above.

The operation of the communication interface unit 602 is shown as a process network with processes 806 to 814.

The arrows illustrate the flow of data (transactions) from the network processor core 801 to the pins 802 and vice versa and between the processes 806 to 814 in the process network.

The processes 806 to 814 are classified into three layers 803 to 805, into the transaction layer 803, the data link layer 804 and the physical layer 805.

The processes from the transaction layer 803 are a transaction layer transmission process 806, a transaction layer control process 807 and a transaction layer reception process 808.

The processes from the data link layer 804 are a data link layer transmission process 809, a data link layer control process 810 and a data link layer reception process 811.

The processes from the physical layer 805 are a physical layer transmission process 812, a physical layer control process 813 and a physical layer reception process 814.

The transaction layer transmission process 806, the data link layer transmission process 809 and the physical layer transmission process 812 are used to send data from the network processor core 801, with each of the processes 806, 809, 812 performing the tasks specific to the layer 803, 804, 805 to which it belongs.

Similarly, the network processor core 801 uses the physical layer reception process 814, the data link layer reception process 811 and the transaction layer reception process 808 to receive data, with each of the processes 808, 811, 814 performing the tasks specific to the respective layer 803, 804, 805 to which it belongs.

Control information and management information is interchanged between the individual processes 806 to 814, so that the communication interface unit 602 can respond to received data immediately, for example.

If the communication interface unit 602 has a plurality of processor elements then the topology on the basis of which the processor elements are coupled and the distribution of the tasks over the processor elements (task mapping) need to allow the data flow 800 shown.

By way of example, it is important for the unidirectional transmission path (transmit path), that is to say the data flow path which is formed by the transaction layer transmission process 806, the data link layer transmission process 809 and the physical layer transmission process 812, and the unidirectional reception path (receive path), that is to say the data flow path which is formed by the physical layer reception process 814, the data link layer reception process 811 and the transaction layer reception process 808, to be coupled to one another, so that they can interchange information, as illustrated in FIG. 8.

The processes 806 to 814 are software processes which are implemented using program instructions executed on the processor elements of the communication interface unit 602, apart from the physical layer transmission process 812 and the physical layer reception process 814, which are respectively implemented by means of a hard macro.

In this case, the physical layer transmission process 812 is implemented by means of the second PHY module 612, and the physical layer reception process 814 is implemented by means of the first PHY module 611.

In another embodiment, the communication interface unit 602 has no processor elements 609, 610, but rather the communication interface unit 602 provides a communication interface using processor elements which are arranged in the network processor core 601, which processor elements use the on-chip communication network, that is to say in this example the connecting network 608, and the output interface 605 and the input interface 606 to access the PHY blocks, that is to say the first PHY module 611 and the second PHY module 612.

Clearly, this embodiment therefore involves the interface function being mapped onto regular processor elements.

This embodiment requires a high level of communication involvement, but it is possible to match the number of processor elements used to provide the communication interface dynamically to the bandwidth requirement of the communication interface and, in particular, to use these processor elements for other tasks when there is a low bandwidth requirement.

### LIST OF REFERENCE SYMBOLS

100 Network processor
101 StrongArm microprocessor
102 RISC microprocessors
103 SDRAM unit
104 PCI unit
105 SRAM unit
106 FBI unit
107 Further functional units
200 Network processor
201 SRAM
202 Fabric
203 External microprocessor
204 Control unit
205 External PROM
206 SDRAM
207 Queue management unit
208 Table lookup unit
209 Processor elements
210 Computer bus
211 Processor
212 SRAM
213 Coprocessors
300 Computer network
301 Computer systems
302 Router
303 Internet
304 WAN
400 Router
401 Housing
402 Fan
403 Line cards
500 Router
501 Line cards
502 Input network interface
503 Output network interface
504 Input switch fabric interface
505 Output switch fabric interface
506 Switch fabric
507 Network processor
508 Memory
509 Coprocessor
510 Computer network
511 Control processor
600 Network processor
601 Network processor core
602 Communication interface unit
603 Input
604 Output
605 Output interface
606 Input interface
607 Communication network processor elements
608 Connecting network
609 Input processor element
610 Output processor element
611,612 PHY modules
700 Processor element
701 Processor element core
702 Data store
703 Instruction stream decoder
704 Checksum processing unit
705 Clock generator unit
706 Program store
707 Input
708 Output
800 Data flowchart
801 Network processor core
802 Pins
803 Transaction layer
804 Data link layer
805 Physical layer
806 Transaction layer transmission process
807 Transaction layer control process
808 Transaction layer reception process
809 Data link layer transmission process
810 Data link layer control process
811 Data link layer reception process
812 Physical layer transmission process
813 Physical layer control process
814 Physical layer reception process

This document cites the following publications:
[1] T. Halfhill. “Intel Network Processor Targets Routers”. Microprocessor Report 13(12), 1999
[2] K. Krewell. “Rainier leads PowerNP family”.

Microprocessor Report, January, 2001
[3] “C-5 Digital Communications Processor”. C-Port Corporation Product Brief, 2000
[4] T. Halfhill. “Ubicom's new NPU stays small”. Microprocessor Report, 2003
[5] G. Giacalone, T. Brightman, et al. “A 200 MHz Digital Communications Processor”. IEEE International Solid-State Circuits Conference (ISSCC), 416-417, 2000
[6] US 2003/0041163 A1
[7] WO 02/12999 A2
[8] US 2003/0105799 A1

1. A network processor having a plurality of programmable processor elements, in which
each processor element from the plurality of processor elements is set up to provide communication network protocol basic functions;
a first portion of the plurality of processor elements are set up as communication network processor elements; and
a second portion of the plurality of processor elements are set up as interface processor elements which are set up to provide an output communication interface and/or an input communication interface on the basis of a communication protocol for the network processor.

2. The network processor as claimed in claim 1, where each processor element from the plurality of processor elements has a bit operation unit for executing operations at bit level, a timer for providing a clocked counter, and a checksum processing unit for processing checksums.

3. The network processor as claimed in claim 1, where each processor element from the plurality of processor elements has a memory for storing data, program instructions and state information and/or a program instruction decoding unit for decoding program instructions.

4. The network processor as claimed in claim 1, where the output communication interface and/or the input communication interface is a switch fabric interface for a switch fabric.

5. The network processor as claimed in claim 1, where the output communication interface and/or the input communication interface is provided on the basis of RapidIO, Hypertransport, PCI Express, CSIX, Ethernet, IEEE 802.3, Token-Ring or ATM.

6. The network processor as claimed in claim 1, where the network processor also has at least one hard macro, and a process which needs to be implemented in order to provide the output communication interface and/or the input communication interface is implemented using program instructions executed on at least one of the interface processor elements or using the at least one hard macro.
